(19) United States
(12) Patent Application Publication
(10) Pub. No.: US 2022/0194642 A1
(43) Pub. Date: Jun. 23, 2022

(54) A METHOD AND A PACKAGING FOR PACKING ONE OR MORE ANIMAL HIDES

(71) Applicant: ECCO Sko A/S, Bredebro (DK)

(72) Inventors: Thomas Gregor, Bredebro (DK); Andre Radtke, Bredebro (DK); Verena Meyer, Bredebro (DK)

(21) Appl. No.: 17/604,349

(22) PCT Filed: Apr. 17, 2020
(86) PCT No.: PCT/EP2020/060860

§ 371 Date: Oct. 15, 2021

(30) Foreign Application Priority Data
Apr. 17, 2019 (EP) 19169802.6

(51) Int. Cl. B65B 31/04; B65B 5/04; B65D 81/20; B65D 81/28

(52) U.S. Cl. CPC B65B 31/04; B65D 81/28; B65D 81/2023; B65B 5/045

(57) ABSTRACT

A method for packing one or more animal hides includes a step of providing a packaging having a first packaging volume configured to contain one or more animal hides and a volume of gas. A further step includes providing the one or more animal hides inside the first packaging volume. The first packaging volume is sealed off from the surrounding environment. A microorganism growth inhibiting environment inside the first packaging volume compared to the surrounding environment is provided.

### TECHNICAL FIELD

A method and a packaging for packing one or more animal hides, the packaging having a packaging volume sealed off from the surrounding environment, where a microorganism growth inhibiting environment is provided inside the packaging volume compared to in said surrounding environment.

### BACKGROUND

During a process of producing leather from animal hides, the animal hides are inter alia treated in three steps involving preparatory stages, tanning, and crusting.

The preparatory stages comprise a number of sub-steps including pre-soaking, fleshing and deliming. The pre-soaking frees the raw material of dirt, such as blood dung and preserving salt and soaking returns it to its original water content. Soaking takes place at a pH between 8 and 10. In the liming step, Sulphur compounds as well as lime can be added to remove the hair off the hide. The proteins are hydrolyzed, i.e. rendered water-soluble, and washed off. At the same time, the lime and Sulphur compounds used in the liming step, which have a powerful reducing effect, attack and rupture the polypeptide chains of the leather hide. This leads to greater mobility of the fibers, which endows the leather with enhanced extensibility and softness. This operation is also known as hide opening. During the entire liming operation, the hide undergoes a process of swelling due to becoming highly anionically charged by the attendant repellence between groups bearing the same charge.

In the fleshing step, remnants of tissue, flesh and fat are removed using sharp bladed rolls. To obtain uniformly thick leather in a desired thickness, the hide can be split. Fleshing and splitting is performed individually for each hide by hand and machine combined. The untanned leather hide is known as a pelt. A pelt has a water content of about 60 to about 80%. The dry matter is about 98% collagen.

The swelling induced in liming by the high alkalinity has to be eliminated before tanning in order that the tanning agents may penetrate into the fibrillar interstices of the hide fiber fabric. In the de-liming the calcium hydroxide in the hide is removed, where this is achieved by adding weak organic acids, for example aliphatic or aromatic dicarboxylic acids such as, for instance, sulphophthalic acid, or by adding weakly acidic inorganic salts, for example ammonium sulphate, ammonium chloride or polyphosphates.

In deliming, the calcium hydroxide in the hide is removed. Optionally, the hide can be further opened up using enzymes. Deliming and bating are performed in a somewhat heated float, i.e. at about 30 to 35° C. The bating and pickling operation takes about 8 to 24 hours at pH 2.5. The hide obtained after bathing and pickling is fully saturated with aqueous solution and is known as a pickled pelt.

At this point the actual tanning is carried out, conventionally taking 12 to 48 hours. The float ratio between the mass of tanning solution and the mass of pickled pelt to be tanned (i.e. the mass of hides fully saturated with aqueous solution) is between 8:1 and 1:1, although typically an excess of tanning solution is used. The tanning operation is frequently carried out in rolling drums and is then known as drum tannage. In addition to water and tanning agent, the tanning liquor contains, for example, salt, formic acid, sulphuric acid, sodium bicarbonate and further added substances. During tanning, the bonding-capable groups on the collagens undergo crosslinking with the tanning agents. The pH is raised to values between 3.6 and 4, by addition of alkali, in contradistinction to the bating and pickling operation.

Following the tanning step, the animal hides may be packed, stored and possibly transported to another location before being treated by crusting. Thus, the time interval from ending the tanning step to initiating the crusting step may range from a few hours or several days to several months. However, keeping the animal hides at a wet blue or wet white state for several days may result in the animal hides decomposing or being damaged, as fungus, spores and microorganisms that are present in ambient air and liquid may develop to extensive contamination of the animal hides during storage and/or transport.

Thus, there is a need for an improved method for packing one or more animal hides, which reduces the risk of animal hides being damaged by contamination of microorganisms, such as fungus.

### GENERAL DESCRIPTION

In accordance with the present description, there is provided a method for packing one or more, such as a plurality of, animal hides comprising: providing a packaging having a first packaging volume; providing the one or more animal hides inside the first packaging volume; sealing off the first packaging volume from the surrounding environment; and providing a microorganism growth inhibiting environment inside the first packaging volume compared to the surrounding environment.

Traditionally, animal hides that are processed and that are made ready for a crusting process are treated with fungicides, as fungal growth, or growth of microorganisms on animal hides is a serious issue that can damage the animal hides before the animal hides are completely processed to be preserved as e.g. a leather. The provision of the above method of packing animal hides, it may be possible to reduce or eliminate the use of biocides, and especially reduce and/or eliminate the use of fungicides in the treatment process of the animal hides. Thus, it may be possible to prepare the animal hides for transport and/or storage without introducing a certain amount of fungicides into the animal hide. The reduction of fungicides in the animal hides may be positive for the environment, as the fungicides have to be washed from the animal hides in some way when the animal hides are further processed.

Within the present description, the term “one or more” may be understood as at least one, but may be a plurality of, such as two, ten, twenty, etc., any number in between or more. For example, at least ten animal hides are packed together, which may be e.g. 50-60 cm high, e.g. 50 cm wide and long, e.g. weigh 100-200 kg, when stacked.

Within the present description, the term “animal hides” may be understood as hides originating from any type of animal. The animal hides may either be untreated, have gone through any of the preparatory stages, tanning, and/or crusting, or may have completed treatment. Therefore, the animal hides may be dry or contain an amount of liquid.

Within the present description, the term “packaging volume” may be understood as an inner volume/opening/container of the packaging, which is configured to contain an item, such as animal hides, and an amount/volume of gas, such as air.

Within the present description, the term “sealing off the packaging volume” may be understood as separating the packaging volume from the surrounding environment, so that exchange of gas or liquid between the packaging volume and the surrounding environment e.g. via an opening is inhibited/eliminated. In case the step of sealing off the packaging volume is done in the ambient air, then the packaging volume may contain both the animal hides and air.

Within the present description, the term “surrounding environment” may be understood as the space surrounding the packaging, where the space surrounding the packaging may e.g. comprise a gas, such as air and/or an inert gas composition, with a fixed or varying temperature, e.g. being below, equal to or above 0 degrees Celsius, and/or with the space being at an absolute pressure below, equal to or above 1 atm.

Within the present description, the term “microorganism growth inhibiting environment” may be understood as a space in which microorganisms are prevented from growing/developing with similar speed/rate as at normal temperature and pressure (NTP). Features inhibiting the microorganism growth may be gas compositions containing a lower concentration of microorganisms such as fungus, mould or spores, or of bacteria, etc. than in atmospheric air at NTP conditions. The concentration of the microorganisms in the gas contained in the packaging volume may be measured in terms of e.g. ppm, mass concentration (kg/m³), molar concentration (mol/m³), number concentration (1/m³) or volume concentration (m³/m³). Therefore, the amount of microorganisms that may develop to e.g. fungus on the animal hides and thereby damage the animal hides may be lower inside the packaging volume than outside the packaging (i.e. in the surrounding environment). Other features that may inhibit the microorganism growth may be temperature, i.e. lowering the temperature reduces the rate of growth of the microorganisms.

When animal hides that have not been tanned are to be stored, the storage conditions of the animal hides are usually in a humid storage, as animal hides that dry out may not be suitable for further processing. Thus, when the animal hides are stored and packed, the animal hides are stored in a humid environment. Environments having a high humidity is often a good environment for fungus growth, which means that animal hides are traditionally treated with fungicides to minimize the fungal growth during storage.

Providing a method for packing one or more animal hides inside a first packaging volume of a packaging facilitates that animal hides may be treated either partly or completely and then stored and/or transported with minimal risk of the animal hides being damaged or contaminated. Further, packing the one or more animal hides ensures that the animal hides are organised and can be easily located and transported.

Sealing off the first packaging volume from the surrounding environment ensures that the animal hides are not exposed to e.g. spores in the surrounding environment. Thereby, the risk of the animal hides being exposed to elements (such as fungus, spores, bacteria, etc.) after the volume has been sealed off, which may be detrimental to the animal hides by e.g. reducing lifetime or alter the structural strength of the hides, may be eliminated or at least significantly reduced.

Microorganisms, such as fungus and/or spores may be detrimental to animal hides. Therefore, providing a microorganism growth inhibiting environment inside the packaging volume compared to the surrounding environment is advantageous, as the amount of fungus, spores, and bacteria is reduced. Thereby, the risk of the animal hides being damaged and/or the time before the damaging starting is reduced significantly, which means that the animal hides may e.g. be transported and stored for an extended period compared to a situation, where the animal hides are not packed in a packaging volume with a reduced microorganism growth.

In an embodiment, providing a microorganism growth inhibiting environment inside the packaging volume compared to the surrounding environment may comprise providing a fungal growth inhibiting environment inside the packaging volume. This means that the environment inside the packaging volume may result in a reduction in the growth rate of fungal growth inside the packaging volume. It has been found that removing ambient air from the packaging volume reduces the rate of fungal growth substantially, or may inhibit the growth substantially, as most types of fungi that are spread as spores in the ambient air require air to grow.

The animal hides are often treated with some forms of chemicals prior to the packaging, i.e. in a tanning process, and are washed in water-based solutions during the processing, which means that the animal hides are mostly void of microorganisms such as fungi, when they finish the tanning process. Thus, when fungi grow on animal hides during storage and/or transport, the source of the fungi predominately from the ambient air. When animal hides are traditionally treated with a fungicide, the fungicide is not intended to kill the fungus in or on the animal hides during the processing, but mainly to prevent future growth of fungi.

In an embodiment, providing a microorganism growth inhibiting environment inside the first packaging volume compared to the surrounding environment can comprise: removing at least part of the volume of fluid present inside the first packaging volume.

Microorganisms such as fungus, spores, mould, etc. which may be present in the air surrounding an animal hide or in the liquid located on or in an animal hide may be damaging to the structure of the animal hides. In case fungus is growing on the animal hides, the animal hides may possibly not be suited for use as leather. Thus, removing at least part of the volume of fluid (e.g. at least removing part of the gas) present inside the packaging volume is advantageous, as the risk of the fungus damaging the animal hides is lowered and/or at least the growth rate of fungus is lowered.

In an embodiment, providing a microorganism growth inhibiting environment inside the first packaging volume compared to the surrounding environment can comprise: introducing a volume of an inert gas and/or filtered and/or clean air into the first packaging volume.

Within the present in the present description, the term “inert gas” may be understood as a gas composition with no concentration of microorganisms (such as fungus or spores), and which does not react with the animal hides or with the fluid surrounding, being on or in the animal hides. The inert gas may be seen as a gas that does not support the growth of fungi, or may inhibit the growth of fungi by being void of air molecules that the fungi needs to grow. Further, an inert gas may be understood as a gas being able to form an atmosphere (consisting of gases such as argon, nitrogen, CO₂, or helium) for oxygen-sensitive or water-sensitive substances (i.e. the animal hides), to prevent unwanted reactions of these substances with oxygen or water.

Filtered air and cleaned air may refer to air filtered and cleaned, respectively, of particles and microorganisms (e.g. spores). Filtering and cleaning air may be done by e.g. directing the air through an air filter before introducing it into the first packaging volume.

Therefore, by introducing a volume of an inert gas and/or filtered and/or cleaned air into the first packaging volume, the concentration of fungus and spores in the packaging volume may be kept low after sealing off the packaging volume from the surrounding environment, which inhibits the growth of e.g. fungus on the animal hides.

In an embodiment, providing a microorganism growth inhibiting environment inside the first packaging volume compared to the surrounding environment can comprise: providing a pressure inside the first packaging volume being lower than the pressure in the surrounding environment.

Providing a pressure inside the first packaging volume being lower than the pressure in the surrounding environment may comprise removing gas from the packaging volume after sealing off the packaging volume, and/or sealing off the packaging volume in a situation where the surrounding environment and the packaging volume is under a reduced pressure, such as below 1 atm (101325 Pa) or e.g. at least 5% below the pressure in the surrounding environment.

The pressure in the surrounding environment may vary depending on a number of different factors, such as the specific altitude in which the packaging is positioned, and whether the surrounding environment is experiencing a high pressure or a low pressure. Therefore, the pressure in the surrounding environment may vary from slightly below 1 atm (101325 Pa) to slightly above 1 atm. Thus, providing a pressure inside the first packaging volume being lower than the pressure in the surrounding environment is to be understood as providing a pressure being lower than the pressure at NTP, including e.g. the variation in pressure due to change altitude. Thus, providing a pressure inside the first packaging volume being lower than the pressure in the surrounding environment may comprise providing a pressure gradient across the wall of the packaging.

Providing a pressure inside the first packaging volume being lower than the pressure in the surrounding environment may comprise providing a vacuum inside the first packaging volume. Vacuum may refer to an absolute pressure below 1 atm, an absolute pressure below 0.01 atm, and/or an absolute pressure below 0.0001 atm.

Providing a pressure inside the first packaging volume being lower than the pressure in the surrounding environment, reduces the amount of microorganisms (e.g. spores) in the gas inside the first packaging volume and thereby inhibits/reduces the growth of e.g. fungus compared to in the surrounding environment.

In an embodiment, providing a microorganism growth inhibiting environment inside the first packaging volume compared to the surrounding environment may comprise: providing a pressure inside the first packaging volume being higher than the pressure in the surrounding environment.

A pressure inside the first packaging volume being higher than the pressure in the surrounding environment may refer to a pressure equal to or above 1 atm (including the variations in pressure indicated above), and/or a pressure above 1 atm and below 1.1 atm, 1.2 atm, 1.3 atm, 1.4 atm or 1.5 atm, and/or a pressure at least 5% above the pressure in the surrounding environment.

Providing a pressure inside the first packaging volume being higher than the pressure in the surrounding environment has the advantage that, in case e.g., the packaging is ruptured (i.e. an opening/aperture is created between the first packaging volume and the surrounding volume, whereby the packaging is not sealed off anymore), a bit of inert gas or filtered air will leave the packaging, initially. Reversely, if the pressure inside the packaging is lower than the pressure in the surrounding environment, air from the surrounding environment will enter the packaging in case of rupture.

In an embodiment, providing a microorganism growth inhibiting environment inside the first packaging volume compared to the surrounding environment may comprise: providing a pressure inside the first packaging volume being between 20% lower and 20% higher than the pressure in the surrounding environment.

Providing a pressure inside the first packaging volume being between 20% lower and 20% higher than the pressure in the surrounding environment facilitates that the above-mentioned advantages of having a microorganism growth inhibiting environment is obtained without affecting the structural integrity of the material of the packaging unnecessarily e.g. by expanding/compressing or stressing the material of the packaging to a high degree.

In an embodiment, the packaging may comprise a flexible material. The packaging may at least partly be made of a flexible material. Thereby, the packaging may easily adapt/adjust to e.g. the applied pressure inside the packaging volume and to a change in the pressure gradient across wall of the packaging. Further, the packaging may easily adjust/adapt to the shape/contour of the animal hides. The packaging may comprise a foil or film. The packaging may comprise a polymer material.

In an embodiment, the packaging may at least partly comprise an elastic material. An elastic material may refer to a material, which is able to resist a distorting influence (e.g. induced by pressure gradient) and to return to its original size and shape when that influence or force is removed.

In an embodiment, the wall of the packaging may comprise a flexible material. The wall may separate the packaging volume from the surrounding environment.

In an embodiment, the packaging can comprise a rigid material. Thereby, the packaging may possibly withstand larger pressure gradients across the packaging wall than if the packaging comprises a flexible material. Further, the packaging may withstand more stress during transportation of the packaging, without being damaged, than if it is made of a flexible material.

In an embodiment, the method can further comprise providing a valve assembly in the packaging, the valve assembly being configured to provide a selective gas flow restriction between the first packaging volume and the surrounding environment.

Thereby, fluid (for example gas) may be removed from the packaging volume or introduced into the packaging volume, when wanted, e.g. if the pressure is to be decreased or increased inside the packaging volume, either once or repetitively.

In an embodiment, the valve assembly can comprise at least one one-way valve and/or at least one two-way valve.

One one-way valve can be provided in the packaging if e.g. gas is only removed from or introduced into the packaging volume. Two on-way valves can be provided in the packaging if gas is to be both removed from and introduced into the packaging volume—also simultaneously. More than two one-way valves can be provided in the packaging if the flow of gas is to be increased.

One two-way valve can be provided in the packaging if gas is to be both removed from or introduced into the packaging volume, whereby one valve less is required compared to using two one-way valves.

In an embodiment, the packaging can comprise at least one second packaging volume.

Thereby, the packaging may comprise two or more packaging volumes, which may be isolated from each other.

Each of the first and second packaging volumes may be configured to contain one or more animal hides and a volume of gas.

By having more than one packaging volume, the animal hides may be stored under varying microorganism growth inhibiting environments. Further, by having more than one packaging volume, the animal hides in the second packaging volume is not necessarily damaged, even though the wall of the first packaging volume is ruptured and the animal hides in the first packaging volume are damaged.

In an embodiment, sealing off the first packaging volume from the surrounding environment can comprise: closing access between the first packaging volume and the surrounding environment by way of welding, adhesion, and/or a mechanical closing arrangement.

Providing the one or more animal hides inside the first packaging volume may comprise introducing the one or more animal hides inside the first packaging volume through an opening in the wall of the packaging. Closing access between the first packaging volume and the surrounding environment may therefore comprise closing the opening in the wall of the packaging through which the animal hides have been introduced.

Closing access may be done by welding. If the packaging comprises a polymer material, the edges at the access (i.e. opening) may be joined and welded together (heat treated). If the packaging material comprises a rigid material such as e.g. a metal or a rigid polymer material, then e.g. a plate covering the opening may be welded to the packaging thereby closing access.

Closing access may be done by adhesion, whereby an adhesive material may be placed at the edges of the access/opening of the packaging followed by joining of the edges.

Closing access may be done by a mechanical closing device, e.g. a zip lock, folding of layers, clamp, peg, clip, bolt and nut, etc. Thus, in case the packaging comprises a flexible material (e.g. a polymer material, film, foil, etc.), closing access may be done by joining the edges of the access (opening/aperture) and applying a clamp.

In an embodiment, providing one or more animal hides inside the first packaging volume can comprise introducing one or more liquid containing animal hides inside the first packaging volume.

Following the tanning step, the animal hides contain liquid such as water and/or some tanning solution. The animal hides may be packed, stored and possibly transported, while still containing fluid, to another location before being treated by crusting.

In an embodiment, the animal hides may be wet blue and/or wet white animal hides. As an example, the animal hides may have been processed by a tanning process, where the animal hides may be tanned, and where the animal hides are ready for further processing to produce a leather.

In an embodiment, liquid containing animal hides can comprise wet blue and/or wet white animal hides.

In an embodiment, the animal hides may have a concentration of fungicides that is less than 0.2 wt %, or preferably less than 0.15 wt %, or preferably less than 0.1 wt %, or preferably approximately 0 wt %.

In an embodiment, the steps of sealing off the packaging volume from the surrounding environment and providing a microorganism growth inhibiting environment inside the packaging volume compared to the surrounding environment, may be in response to providing one or more animal hides inside the packaging volume.

In accordance with the present description, there is further provided a packaging for packing one or more animal hides according to the above-mentioned method.

Various exemplary embodiments and details are described hereinafter, with reference to the figures when relevant. It should be noted that the figures may or may not be drawn to scale and that elements of similar structures or functions are represented by like reference numerals throughout the figures. It should also be noted that the figures are only intended to facilitate the description of the embodiments. They are not intended as an exhaustive description of the invention or as a limitation on the scope of the invention. In addition, an illustrated embodiment needs not have all the aspects or advantages shown. An aspect or an advantage described in conjunction with a particular embodiment is not necessarily limited to that embodiment and can be practiced in any other embodiments even if not so illustrated, or if not so explicitly described.

The packaging may be a gas-tight packaging material, where the packaging material may be gas tight, water-tight, and where the packaging is impermeable to, water molecules, air molecules and CO₂ molecules, so that when the packaging is closed the environmental air cannot penetrate hermetically sealed packaging material. The packaging material may a FIBC wrapping liner from VQM packaging BV, Biezenwei 6, 4004 MB Tiel, in the Netherlands. The packaging material may be a layered construction including PA/EVOH/PA.

### BRIEF DESCRIPTION OF THE DRAWINGS

The following is an explanation of exemplary embodiments with reference to the drawings, in which

FIG. 1 shows a schematic view of an embodiment of a method for packing one or more animal hides.

### DETAILED DESCRIPTION

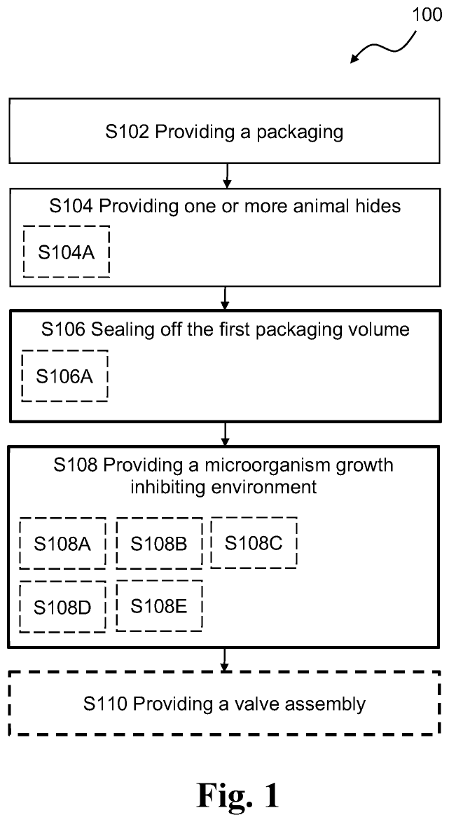

FIG. 1 shows an embodiment of a method for packing one or more animal hides.

The present description discloses a method (100) for packing one or more animal hides. The animal hides may be either contain an amount of fluid or be dry.

The method comprises a step of providing (S102) a packaging having a first packaging volume configured to contain one or more animal hides and a volume of gas. The packaging may be in the shape of a container comprising a rigid material, so that the outer wall of the container is solid and may withstand stress e.g. during transport. Alternatively, the packaging may comprise a flexible material and may therefore be produced as a bag or as a foil, which is wrapped around the animal hides thereby forming a packaging.

The method further comprises a step of providing (S104) the one or more animal hides inside the first packaging volume. Optionally, one or more animal hides may be provided inside the first packaging volume by introducing (S104A) one or more animal hides inside the first packaging volume. Thus, in case the packaging is a container or a bag, the animal hides may thereby be introduced into the first (or second) packaging volume through an opening. Alternatively, in case the packaging is formed by a foil, the foil may be wrapped around the animal hides, after the animal hides have been stacked on e.g. a pallet.

The method further comprises a step of sealing off (S106) the first packaging volume from the surrounding environment. Optionally, sealing off (S106) the first packaging volume from the surrounding environment may comprise closing (S106A) access between the first packaging volume and the surrounding environment by way of welding, adhesion and/or a mechanical closing arrangement. The step of sealing off (S106) may be carried out in response to providing one or more animal hides inside the packaging volume.

The method further comprises a step of providing (S108) a microorganism growth inhibiting environment inside the first packaging volume compared to the surrounding environment.

Optionally, providing (S108) a microorganism growth inhibiting environment inside the first packaging volume compared to the surrounding environment may comprise removing (S108A) at least part of the volume of gas present inside the first packaging volume. Removing a volume of gas may be done by connecting a fluid pump, such as an air pump (diaphragm pump, reciprocating pump), to a valve on the packaging. The gas is then pumped out of the packaging, where the removal of the air may also remove air based contaminants, such as microorganisms, from the packaging.

Optionally, providing (S108) a microorganism growth inhibiting environment inside the first packaging volume compared to the surrounding environment may comprise introducing (S108B) a volume of an inert gas and/or filtered and/or clean air into the first packaging volume. Introducing a volume of gas may be done by connecting a fluid pump, such as an air pump (diaphragm pump, reciprocating pump), to a valve on the packaging. Alternatively, the inert gas and/or filtered air may be pressurised, such as in a pressure cylinder, whereby the gas and/or filtered air may be lead into the first (or second) packaging volume via a valve on the packaging, due to the high pressure gradient between the pressure cylinder and the packaging volume.

Optionally, providing (S108) a microorganism growth inhibiting environment inside the first packaging volume compared to the surrounding environment may comprise providing (S108C) a pressure inside the first packaging volume being lower than the pressure in the surrounding environment.

Optionally, the step of providing (S108) a microorganism growth inhibiting environment inside the first packaging volume compared to the surrounding environment may comprise providing (S108D) a pressure inside the first packaging volume being higher than the pressure in the surrounding environment.

Optionally, the step of providing (S108) a microorganism growth inhibiting environment inside the first packaging volume compared to the surrounding environment may comprise providing (S108E) a pressure inside the first packaging volume being in a range between 20% lower and 20% higher than the pressure in the surrounding environment.

The step of providing (S108) a microorganism growth inhibiting environment inside the first packaging volume may be carried out in response to providing one or more animal hides inside the packaging volume, and/or sealing off (S106) the first packaging volume.

The method may further comprise providing (S110) a valve assembly in the packaging, where the valve assembly is configured to provide a selective gas flow restriction between the first packaging volume and the surrounding environment. Thus, the valve assembly, which may comprise a one-way and/or a two-way valve, may be arranged in the wall of the packaging after the step of sealing off (S106) the first packaging volume and/or may be arranged at an opening of the packaging in connection with closing (S106A) access between the first packaging volume and the surrounding environment.

In one embodiment, the packaging volume of the packaging may be greater than 2 cubic metres (m³), and may preferably be greater than 3 cubic metres (m³), and may preferably be around 4 cubic metres (m³).

In one embodiment, the animal hides may be wet blue, having a water concentration of about 50-60 wt %. Thus, if the total weight of the animal hides is about 1000 kg, the weight of the water inside the animal hides is about 500-600 kg.

### EXAMPLE

In one example, the packing of the animal hides may be performed by positioning a pallet on a plane surface, such as the ground. A packaging foil may be positioned on top of the pallet, where the packaging volume may be exposed to the environment. The animal hides, often in a wet blue state, may be stacked inside the packaging volume until a predetermined amount of animal hides is inside the packaging volume. The packaging may subsequently be sealed off, by welding the opening in the packaging and closing off the packaging volume from the environment, where the animal hides are hermetically sealed from the environment. A vacuum pump may be attached to a valve which provides fluid communication to the packaging volume, where the vacuum pump is initiated to pump out the air from the packaging volume and the packaging, removing most of the air from the packaging. The vacuum pump may be detached from the packaging, where the valve ensures that air from the outside cannot enter the packaging volume and therefore maintains the lower pressure inside the packaging volume. A source of CO2 is connected to the packaging via a valve, where CO2 may be introduced into the packaging volume, so that the concentration of C02 inside the packaging volume is approximately 98% (at least above 90%). When the CO2 source is released from the packaging the valve ensures that the CO2 remains inside the packaging volume.

The use of the terms “first”, “second”, “third” and “fourth”, “primary”, “secondary”, “tertiary” etc. does not imply any particular order, but are included to identify individual elements. Moreover, the use of the terms “first”, “second”, “third” and “fourth”, “primary”, “secondary”, “tertiary” etc. does not denote any order or importance, but rather the terms “first”, “second”, “third” and “fourth”, “primary”, “secondary”, “tertiary” etc. are used to distinguish one element from another. Note that the words “first”, “second”, “third” and “fourth”, “primary”, “secondary”, “tertiary” etc. are used here and elsewhere for labelling purposes only and are not intended to denote any specific spatial or temporal ordering.

Furthermore, the labelling of a first element does not imply the presence of a second element and vice versa.

It is to be noted that the word “comprising” does not necessarily exclude the presence of other elements or steps than those listed.

It is to be noted that the words “a” or “an” preceding an element do not exclude the presence of a plurality of such elements.

It should further be noted that any reference signs do not limit the scope of the claims, that the exemplary embodiments may be implemented at least in part by means of both hardware and software, and that several “means”, “units” or “devices” may be represented by the same item of hardware.

Although features have been shown and described, it will be understood that they are not intended to limit the claimed invention, and it will be made obvious to those skilled in the art that various changes and modifications may be made without departing from the spirit and scope of the claimed invention. The specification and drawings are, accordingly to be regarded in an illustrative rather than restrictive sense. The claimed invention is intended to cover all alternatives, modifications, and equivalents.

1. A method for packing one or more animal hides comprising:
providing a packaging having a first packaging volume;
providing the one or more animal hides inside the first packaging volume;
sealing off the first packaging volume from the surrounding environment;
providing a microorganism growth inhibiting environment inside the first packaging volume compared to the surrounding environment, wherein providing a microorganism growth inhibiting environment inside the first packaging volume compared to the surrounding environment comprises removing at least part of the volume of gas present inside the first packaging volume; and
introducing a volume of an inert gas and/or filtered and/or clean air into the first packaging volume.

2. (canceled)

3. The method according to claim 1, wherein providing a microorganism growth inhibiting environment inside the first packaging volume compared to the surrounding environment comprises:
providing a pressure inside the first packaging volume being lower than the pressure in the surrounding environment.

4. The method according to claim 1, wherein providing a microorganism growth inhibiting environment inside the first packaging volume compared to the surrounding environment comprises:
providing a pressure inside the first packaging volume being higher than the pressure in the surrounding environment.

5. The method according to claim 1, wherein providing a microorganism growth inhibiting environment inside the first packaging volume compared to the surrounding environment comprises:
providing a pressure inside the first packaging volume being in a range between 20% lower and 20% higher than the pressure in the surrounding environment.

6. The method according to claim 1, wherein the packaging comprises a flexible material.

7. The method according to claim 1, wherein the method further comprises providing a valve assembly in the packaging, where the valve assembly is configured to provide a selective gas flow restriction between the first packaging volume and the surrounding environment.

8. The method according to claim 7, wherein the valve assembly comprises at least one one-way valve and/or at least one two-way valve.

9. The method according to claim 1, wherein the packaging volume is a first packaging volume is a first packaging volume, and the packaging further having at least one second packaging volume.

10. The method according to claim 1,
wherein sealing off the first packaging volume from the surrounding environment comprises:
closing access between the first packaging volume and the surrounding environment by way of welding, adhesion, and/or a mechanical closing arrangement.

11. The method according to claim 1, wherein providing one or more animal hides inside the first packaging volume comprises:
introducing one or more liquid containing animal hides inside the first packaging volume.

12. The method according to claim 11, wherein fluid containing animal hides comprises wet blue and/or wet white animal hides.

13. The method according to claim 1, wherein the animal hides have a concentration of fungicides that is less than 0.2 wt %, or preferably less than 0.15 wt %, or preferably less than 0.1 wt %, or preferably approximately 0 wt %.

14. A packaging for packing one or more animal hides the packaging comprising:
a package having a packaging volume sized to accommodate one or more animal hides inside thereof, the packaging volume being sealable from a surrounding environment; and
a microorganism growth inhibiting environment provided inside the packaging volume, the microorganism growth inhibiting environment being provided at least in part by removal of at least part of a volume of gas present inside the packaging volume.
